(19) United States
(12) Patent Application Publication
(10) Pub. No.: US 2006/0242246 A1
(43) Pub. Date: Oct. 26, 2006

(54) Managing the delivery of queued instant messages

(75) Inventors: Ruthie D. Lyle, Durham, NC (US); Fonda J. Daniels, Cary, NC (US)

Correspondence Address: CAREY, RODRIGUEZ, GREENBERG & PAUL, LLP;STEVEN M. GREENBERG, 1300 CORPORATE CENTER WAY, SUITE 105G, WELLINGTON, FL, 33414, US

(73) Assignee: International Business Machines Corporation, Armonk, NY (US)

(21) Appl. No.: 11/110,239

(22) Filed: Apr. 20, 2005

(51) Int. Cl. G06F 15/16

(52) U.S. Cl. 709/206

(57) ABSTRACT

A method and apparatus for managing the delivery of instant messages in a queue. The method can include designating a recipient of a composed instant message. Responsive to determining that the recipient is in a state in which the recipient is not receiving instant messages, the composed instant message can be queued for deferred delivery. Subsequently, a state change can be detected in the recipient. Finally, responsive to the detection, the queued instant message can be forwarded to the recipient.

### BACKGROUND OF THE INVENTION

1. Statement of the Technical Field

The present invention relates to the field of collaborative computing and more particularly to instant messaging and chat systems.

2. Description of the Related Art

Real time communications systems provide a substantial enhancement over more traditional, asynchronous communications systems. Electronic mail delivery systems, the prototypical asynchronous communications systems, in its time represented a giant leap forward in respect to global interpersonal communications. Prior to electronic mail, individuals primarily communicated via telephone, facsimile and post. With electronic mail, however, individuals expect near instant delivery of text, and even imagery, audio and video, without incurring the delay typical of the postal system, or the expense associated with telephony and fax technologies.

Despite the ubiquity of electronic mail, asynchronous communications systems lack several elements common in the realm of real time communications systems. In particular, the seemingly instant delivery of a message cannot be experienced in the world of electronic mail. In a real-time society, the minor latencies associated with electronic mail often cannot be suitable for the task at hand where a real-time conversation will be required in addressing a problem or performing a collaborative task. More importantly, often the feel and nature of a “conversation” as it is known to human beings only can be approximated through real time communications where the participants to a conversation feel the spontaneity of an exchange of ideas, much as is the case in a live, face-to-face conversation.

The recent rapid development of the Internet has led to advanced modes of synchronous, real-time collaboration able to fulfill the real-time communicative requirements of the modem computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include several human-to-human collaborative environments such as instant messaging and persistent chat rooms.

Within a human-to-human collaborative environment such as an instant messenger, it is possible for a user to intentionally prevent the delivery of messages transmitted by other users. Typically, such a state is known as “Offline” or “Do Not Disturb”. Users attempting to instant message a recipient who is offline or in a do not disturb state will be notified before transmitting a message that it is unlikely that the intended recipient is online and able to receive the message.

When sending a message to an intended recipient despite the offline status of the intended recipient, the sender will never know with certainty if the message has been received by the intended recipient. Moreover, if a sender chooses to send a message to a recipient despite the offline state or do not disturb state, the message will be lost. At best, the sender can be notified of when the intended recipient enters a receptive state in which the intended recipient can receive a message. Still, senders often would prefer to be able to send a message at the time the message is composed and not when the intended recipient is available.

### SUMMARY OF THE INVENTION

The present invention addresses the deficiencies of the art in respect to instant messaging and provides a novel and non-obvious method and apparatus for managing the delivery of instant messages in a queue. The method can include designating a recipient of a composed instant message. Responsive to determining that the recipient is in a state in which the recipient is not receiving instant messages, the composed instant message can be queued for deferred delivery. Subsequently, a state change can be detected in the recipient. Finally, responsive to the detection, the queued instant message can be forwarded to the recipient.

In one aspect of the invention, the forwarding step can include, responsive to detecting a termination of an instant messaging session by the recipient, prompting a sender of the instant message to discard the queued instant message, prompting a sender of the instant message to save the queued instant message for delivery upon the recipient establishing a new instant message session, prompting a sender of the instant message to convert the queued instant message to one of an e-mail and a voice mail for delivery to the recipient, or prompting a sender of the instant message to send the queued instant message despite the termination.

In another aspect of the invention, the forwarding step can include, responsive to detecting the recipient changing to a state in which the recipient is receiving instant messages, prompting a sender of the instant message to discard the queued instant message, prompting a sender of the instant message to send the queued instant message to the recipient, and prompting a sender of the instant message to review and edit the queued instant message before sending the queued instant message to the recipient. In yet another aspect of the invention, the method further can include, responsive to detecting a termination of an instant messaging system by a sender of the queued instant message, prompting a sender of the instant message to discard the queued instant message, or prompting a sender of the instant message to convert the queued instant message to one of an e-mail and a voice mail for delivery to the recipient.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for managing the delivery of instant messages in a message queue; and,

FIG. 2 is a flow chart illustrating a process for managing the delivery of instant messages in a message queue.

### DETAILED DESCRIPTION OF THE PREFERRED EMBODIMENTS

The present invention is a method, system and apparatus for managing the delivery of instant messages in a message queue. In accordance with the present invention, an instant message can be queued for subsequent delivery when an intended recipient of the instant message is determined to be unable to receive the instant message. Responsive to the intended recipient become able to receive the instant message, the sender of the instant message can be prompted to forward the instant message in the queue to the intended recipient, to edit the instant before sending the instant message to the intended recipient, or to discard the instant message.

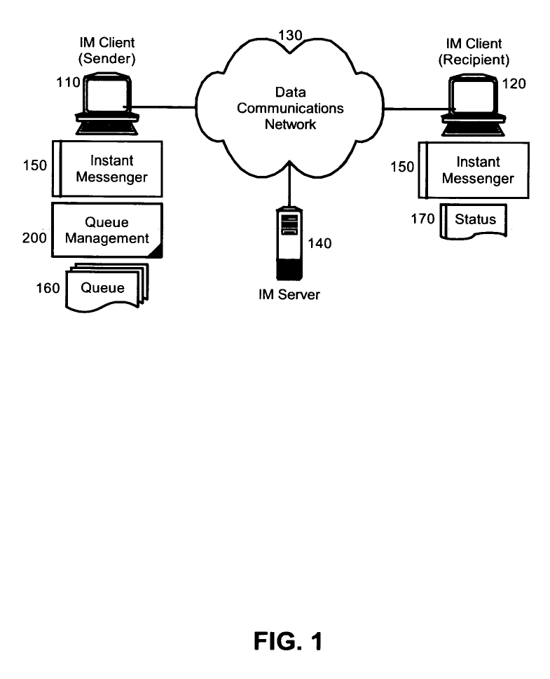

In further illustration, FIG. 1 is a schematic illustration of a system for managing the delivery of instant messages in a message queue. The system can include an instant messaging client 110 configured with instant messaging logic 150. The instant messaging client 110 can be communicatively linked to another instant messaging client 120 also configured with instant messaging logic 150. In this way, the instant messaging client 110 (acting as a sender) can transmit instant messages over the data communications network 130 to the instant messaging client 120 (acting as a recipient). Optionally, an instant messaging server 140 can facilitate the exchange of instant messages between the instant messaging clients 110, 120, although the instant messaging clients 110, 120 need not reside in the same instant messaging network and the instant messaging clients 110, 120 can reside in different instant messaging networks.

Notably, queue management logic 200 can be coupled to the instant messenger 150 in the instant messaging client 110. The queue management logic 200 can include programming to determine when the status 170 of the instant messaging client 120 is set to a state in which the instant messaging client 120 is not accepting instant messages. In the circumstance where the instant messaging client 120 is not accepting instant messages, the queue management logic 200 can add newly composed instant messages intended for receipt by the instant messaging client 120 to a queue 160. Subsequently, the queue management logic 200 can manage the instant messages in the queue 160.

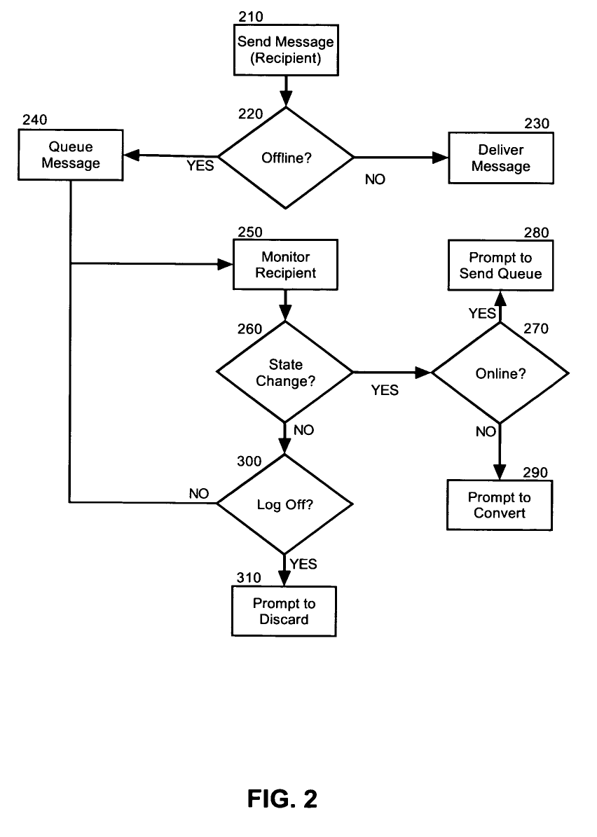

More specifically, FIG. 2 is a flow chart illustrating a process for managing the delivery of instant messages in a message queue. Beginning in block 210, a message can composed and addressed for delivery to a recipient. In decision block 220, it can be determined whether the recipient is in a state in which incoming instant messages are not received for viewing by the recipient. If not, in decision block 230, the instant message can be forwarded to the recipient. Otherwise, the process can continue through block 240 in which the instant message can be queued for later delivery.

In block 250, the state of the recipient can be monitored to determine when the recipient no longer is in a state in which incoming instant messages are not received for viewing by the recipient. If in decision block 260, a state change is not detected, in decision block 300 it can be determined whether the sender of the instant message has terminated the instant messaging session. If so, in block 310 the sender can be prompted to manage the instant messages in the queue in a number of ways. For instance, the sender can discard the instant messages in the queue, the sender can save the instant messages for delivery in a different session, the sender can send the messages as is when the state of the recipient has changed so as to permit the receipt of instant messages, the instant messages in the queue can be converted to e-mail and routed to the recipient, or the instant messages in the queue can be converted to voice mail and placed in an voice mail box for the recipient.

Returning now to decision block 260, if a state change is detected in the recipient, in decision block 270 it can be determined whether the new state of the recipient is such that instant messages can be received and viewed by the recipient, or whether the recipient has terminated the instant messaging session. If the recipient has terminated the instant messaging session, in block 290, the sender can be prompted to manage the instant messages in the queue in a number of ways. For instance, the sender can discard the instant messages in the queue, the sender can save the instant messages for delivery in a different session, the sender can send the messages as is when the recipient establishes a new instant messaging session, the instant messages in the queue can be converted to e-mail and routed to the recipient, or the instant messages in the queue can be converted to voice mail and placed in an voice mail box for the recipient.

Returning now to decision block 270, if the recipient has entered a state in which instant messages can be received and viewed, in block 280 the sender can be prompted to manage the instant messages in the queue in a number of ways. For instance, the sender can discard the instant messages in the queue, the sender can send the messages as is, or the sender can selectively review and edit the instant messages in the queue before selectively sending them to the recipient.

Notably, the process of FIG. 2 can be applied not only to a single recipient of instant messages in the queue, but also multiple recipients. In the latter circumstance, the actions to be performed with respect to the queue can vary from recipient to recipient based upon the rules of an established policy. Consequently, a greater flexibility can be achieved in the management of instant messages where a designated recipient is in a state in which the recipient cannot receive and view instant messages.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for managing the delivery of instant messages in a queue comprising the steps of:
designating a recipient of a composed instant message;
responsive to determining that said recipient is in a state in which said recipient is not receiving instant messages, queuing said composed instant message for deferred delivery;
detecting a state change in said recipient; and,
responsive to said detection, forwarding said queued instant message to said recipient.

2. The method of claim 1, wherein said forwarding step comprises the step of responsive to detecting a termination of an instant messaging session by said recipient, prompting a sender of said instant message to discard said queued instant message.

3. The method of claim 1, wherein said forwarding step comprises the step of responsive to detecting a termination of an instant messaging session by said recipient, prompting a sender of said instant message to save said queued instant message for delivery upon said recipient establishing a new instant message session.

4. The method of claim 1, wherein said forwarding step comprises the step of responsive to detecting a termination of an instant messaging system by said recipient, prompting a sender of said instant message to convert said queued instant message to one of an e-mail and a voice mail for delivery to said recipient.

5. The method of claim 1, wherein said forwarding step comprises the step of responsive to detecting a termination of an instant messaging system by said recipient, prompting a sender of said instant message to send said queued instant message despite said termination.

6. The method of claim 1, wherein said forwarding step comprises the step of responsive to detecting said recipient changing to a state in which said recipient is receiving instant messages, prompting a sender of said instant message to discard said queued instant message.

7. The method of claim 1, wherein said forwarding step comprises the step of responsive to detecting said recipient changing to a state in which said recipient is receiving instant messages, prompting a sender of said instant message to send said queued instant message to said recipient.

8. The method of claim 1, wherein said forwarding step comprises the step of responsive to detecting said recipient changing to a state in which said recipient is receiving instant messages, prompting a sender of said instant message to review and edit said queued instant message before sending said queued instant message to said recipient.

9. The method of claim 1, further comprising the step of responsive to detecting a termination of an instant messaging system by a sender of said queued instant message, prompting a sender of said instant message to discard said queued instant message.

10. The method of claim 1, further comprising the step of responsive to detecting a termination of an instant messaging system by a sender of said queued instant message, prompting a sender of said instant message to convert said queued instant message to one of an e-mail and a voice mail for delivery to said recipient.

11. A machine readable storage having stored thereon a computer program for managing the delivery of instant messages in a queue, the computer program comprising a routine set of instructions which when executed by a machine causes the machine to perform the steps of:
designating a recipient of a composed instant message;
responsive to determining that said recipient is in a state in which said recipient is not receiving instant messages, queuing said composed instant message for deferred delivery;
detecting a state change in said recipient; and,
responsive to said detection, forwarding said queued instant message to said recipient.

12. The machine readable storage of claim 11, wherein said forwarding step comprises the step of responsive to detecting a termination of an instant messaging session by said recipient, prompting a sender of said instant message to discard said queued instant message.

13. The machine readable storage of claim 11, wherein said forwarding step comprises the step of responsive to detecting a termination of an instant messaging session by said recipient, prompting a sender of said instant message to save said queued instant message for delivery upon said recipient establishing a new instant message session.

14. The machine readable storage of claim 11, wherein said forwarding step comprises the step of responsive to detecting a termination of an instant messaging system by said recipient, prompting a sender of said instant message to convert said queued instant message to one of an e-mail and a voice mail for delivery to said recipient.

15. The machine readable storage of claim 11, wherein said forwarding step comprises the step of responsive to detecting a termination of an instant messaging system by said recipient, prompting a sender of said instant message to send said queued instant message despite said termination.

16. The machine readable storage of claim 11, wherein said forwarding step comprises the step of responsive to detecting said recipient changing to a state in which said recipient is receiving instant messages, prompting a sender of said instant message to discard said queued instant message.

17. The machine readable storage of claim 11, wherein said forwarding step comprises the step of responsive to detecting said recipient changing to a state in which said recipient is receiving instant messages, prompting a sender of said instant message to send said queued instant message to said recipient.

18. The machine readable storage of claim 11, wherein said forwarding step comprises the step of responsive to detecting said recipient changing to a state in which said recipient is receiving instant messages, prompting a sender of said instant message to review and edit said queued instant message before sending said queued instant message to said recipient.

19. The machine readable storage of claim 11, further comprising an additional set of instructions which when executed by the machine causes the machine to further perform the step of responsive to detecting a termination of an instant messaging system by a sender of said queued instant message, prompting a sender of said instant message to discard said queued instant message.

20. The machine readable storage of claim 11, further comprising an additional set of instructions which when executed by the machine causes the machine to further perform the step of responsive to detecting a termination of an instant messaging system by a sender of said queued instant message, prompting a sender of said instant message to convert said queued instant message to one of an e-mail and a voice mail for delivery to said recipient.
